(19) United States
(12) Patent Application Publication
(10) Pub. No.: US 2016/0354765 A1
(43) Pub. Date: Dec. 8, 2016

(54) Nb-Zr-Al-Mixed Oxide Supports for Rh Layer use in TWC Converters

(71) Applicant: Clean Diesel Technologies, Inc., Oxnard, CA (US)

(72) Inventors: Randal L. Hatfield, Port Hueneme, CA (US); Zahra Nazarpoor, Camarillo, CA (US); Johnny T. Ngo, Oxnard, CA (US); Stephen J. Golden, Santa Barbara, CA (US)

(21) Appl. No.: 14/732,379

(22) Filed: Jun. 5, 2015

(51) Int. Cl. B01J 23/847; B01D 53/94; B01J 35/00; B01J 35/02; B01J 23/20; B01J 23/46

(52) U.S. Cl. CPC B01J 23/8474; B01J 23/20; B01J 23/464; B01J 35/0006; B01J 35/02; B01D 53/945; B01D 2255/40; B01D 2255/1025; B01D 2255/1021; B01D 2255/1023

(57) ABSTRACT

The present disclosure describes support oxides, including include Niobium Oxide, which are employed in three-way catalytic (TWC) systems. Disclosed herein are TWC sample systems that are configured to include a substrate and one or more of a washcoat layer, an impregnation layer, and/or an overcoat layer. The disclosed one or more of washcoat layer and/or overcoat layer are formed using a slurry that includes an oxide mixture and an Oxygen Storage Material. The disclosed oxide mixtures include niobium oxide (Nb2O5), zirconia, and alumina. Further, other disclosed oxide mixtures additionally include NiO.

### BACKGROUND

### Field of the Disclosure

The present disclosure relates in general to materials used in three-way catalytic (TWC) converters, and more specifically, to support materials employed in TWC converters.

### Background Information

Current automotive catalysts largely depend on platinum group metals (e.g., Platinum, Palladium, and Rhodium) in order to convert vehicle emissions to less noxious substances. However, the supply of said metals is limited even as automobile production increases as a larger portion of the world population adopts motorized vehicles for transport. Additionally, environmental concerns have led to ever more stringent NOx, hydrocarbon, and particulate emission regulations being adopted in countries throughout the world. As such, there is a continuing need for catalysts able to provide better catalytic performance while maintaining reasonable use of platinum group metals.

### SUMMARY

The present disclosure describes support oxides, including Niobium Oxide, which are employed in three-way catalytic (TWC) systems that include Rhodium.

In some embodiments, TWCs are configured to include a substrate and one or more of a washcoat layer, an impregnation layer, and/or an overcoat layer. In these embodiments, the washcoat layer is deposited onto the substrate, the impregnation layer is deposited onto the washcoat layer, and the overcoat layer is deposited onto the washcoat/impregnation layer. Further to these embodiments, one or more of a washcoat layer and/or an overcoat layer are formed using a slurry that includes 20 wt % to 80 wt % oxide mixture, and 0% wt % to 80% wt % Oxygen Storage Material (OSM). In these embodiments, said oxide mixture includes niobium oxide (Nb₂O₅) in a range from about 1 wt % to about 25 wt %, zirconia in a range from about 1 wt % to about 60 wt %, and alumina for the remaining amount, where alumina is included in an amount greater than or equal to about 30%. In other embodiments, said oxide mixture additionally includes NiO in a range from about 0 wt % to about 2 wt %.

In some embodiments, samples are produced for catalytic conversion comparisons and to ascertain the effect of varying compositions on catalytic activity. In these embodiments, the samples include, but are not limited to: reference samples made using conventional materials and synthesis methods; samples made with 1 wt %, 2 wt %, 5 wt %, 10 wt %, and 15 wt % Nb₂O₅ within an oxide mixture that includes 20% wt % zirconia and alumina for the remaining amount, referred to as catalysts Type A, B, C, D, and E, respectively; samples made with 10 wt %, 20 wt %, 30 wt %, 40 wt %, 50 wt %, and 60 wt % zirconia within an oxide mixture that includes 10 wt % Nb₂O₅ and alumina for the remaining amount, referred to as catalysts Type F, G, H, I, J, and K, respectively; samples made with 80 wt %, 60 wt %, 40 wt %, and 20 wt % OSM within the washcoat and oxide mixture for the remaining amounts are referred to as catalysts Type L, M, N, and O, respectively; samples made with a slurry having a PGM loading of 15.1 g/ft3 Rhodium (Rh), 25.7 g/ft3 Rh, 7.4 g/ft3 Platinum (Pt) and 7.4 g/ft3 Rh, and 12.7 Pt Pt and 12.7 Rh, are referred to as catalysts Type P, Q, R, and S, respectively; a sample having an OSM and alumina washcoat, impregnated with a palladium solution, and coated with an overcoat that includes 40 wt % OSM and 60 wt % of an oxide mixture having 10 wt % Nb₂O₅, 20 wt % zirconia, and alumina for the remaining amount is referred to as a catalyst Type T; and samples made with 0 wt % and 2 wt % NiO as part of an oxide mixture applied as part of a washcoat that includes 40% OSM and 60% oxide mixture are referred to as catalyst Type U and Type V, respectively.

In other embodiments, the catalytic efficiency of TWC systems employing various catalytic materials is evaluated by performing a light-off test to determine the Temperature at which 50% Conversion (T50) and the Temperature at which 90% conversion (T90) of pollutants including Nitrogen Oxides (NOx), Carbon Monoxide (CO), and Hydrocarbons (HC) is achieved. In these embodiments, the T50 and T90 conversion values associated with a catalyst are evaluated by providing a core sample from the catalyst (e.g., by using a diamond core drill), experimentally aging the core sample using heat in a controlled chemical environment, and testing said core sample with a bench flow reactor to determine TWC performance.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a graphical representation illustrating a catalyst structure used for Three-Way Catalyst (TWC) samples including a substrate, a washcoat layer, an impregnation layer, and an overcoat layer, according to an embodiment.

FIG. 2 is a graphical representation illustrating a comparison of T50 values of NOx, CO, and HC for REF #1, REF #2, and catalysts Type A, B, C, D, and E, according to an embodiment.

FIG. 3 is a graphical representation illustrating a comparison of T90 values of NOx, CO, and HC for REF #1, REF #2, and catalysts Type A, B, C, D, and E, according to an embodiment.

FIG. 4 is a graphical representation illustrating a comparison of T50 values of NOx, CO, and HC for REF #1, REF #2, and catalysts Type F, G, H, I, J, and K, according to an embodiment.

FIG. 5 is a graphical representation illustrating a comparison of T90 values of NOx, CO, and HC for REF #1, REF #2, and catalysts Type F, G, H, I, J, and K, according to an embodiment.

FIG. 6 is a graphical representation illustrating a comparison of T50 values of NOx, CO, and HC for REF #1, REF #2, and catalysts Type L, M, N, and O, according to an embodiment.

FIG. 7 is a graphical representation illustrating a comparison of T90 values of NOx, CO, and HC for REF #1, REF #2, and catalysts Type L, M, N, and O, according to an embodiment.

FIG. 8 is a graphical representation illustrating a comparison of T50 values of NOx, CO, and HC for catalysts Type D, P, Q, R, and S, according to an embodiment.

FIG. 9 is a graphical representation illustrating a comparison of T90 values of NOx, CO, and HC for Type catalysts D, P, Q, R, and S, according to an embodiment.

FIG. 10 is is a graphical representation illustrating a comparison of T50 values of NOx, CO, and HC for a catalyst Type T and a REF #3 catalyst, according to an embodiment.

FIG. 11 is a graphical representation illustrating a comparison of T90 values of NOx, CO, and HC for a catalyst Type T and a REF #3 catalyst, according to an embodiment.

FIG. 12 is a graphical representation illustrating a comparison of T50 values of NOx, CO, and HC for catalysts Type U and Type V, according to an embodiment.

FIG. 13 is a graphical representation illustrating a comparison of T90 values of NOx, CO, and HC for catalysts Type U and Type V, according to an embodiment.

### DETAILED DESCRIPTION

The present disclosure is described herein in detail with reference to embodiments illustrated in the drawings, which form a part hereof. Other embodiments may be used and/or other modifications may be made without departing from the scope or spirit of the present disclosure. The illustrative embodiments described in the detailed description are not meant to be limiting of the subject matter presented.

### Definitions

As used here, the following terms have the following definitions:

“Air/Fuel ratio or A/F ratio” refers to the mass ratio of air to fuel present in a combustion process.

“Calcination” refers to a thermal treatment process applied to solid materials, in presence of air, to bring about a thermal decomposition, phase transition, or removal of a volatile fraction at temperatures below the melting point of the solid materials.

“Catalyst” refers to one or more materials that may be of use in the conversion of one or more other materials.

“Catalyst system” refers to any system including a catalyst, such as, a PGM catalyst or a ZPGM catalyst of at least two layers comprising a substrate, a washcoat and/or an overcoat.

“Conversion” refers to the chemical alteration of at least one material into one or more other materials.

“Lean condition” refers to exhaust gas condition with an R value less than 1.

“Platinum group metals (PGM)” refers to platinum, palladium, ruthenium, iridium, osmium, and rhodium.

“R value” refers to the value obtained by dividing the total reducing potential of the gas mixture (in Moles of Oxygen) by the total oxidizing potential of the gas mixture (in moles of Oxygen).

“Rich condition” refers to exhaust gas condition with an R value greater than 1.

“Synthesis method” refers to a process by which chemical reactions and/or mixing occur to form a catalyst from different precursor materials.

“T₅₀” refers to the temperature at which 50% of a material is converted.

“T₉₀” refers to the temperature at which 90% of a material is converted.

“Three-Way Catalyst” refers to a catalyst able to perform the three simultaneous tasks of reduction of nitrogen oxides to nitrogen, oxidation of carbon monoxide to carbon dioxide, and oxidation of unburnt hydrocarbons to carbon dioxide and water.

### DESCRIPTION OF THE DRAWINGS

Disclosed herein are materials of use as support oxides in catalytic converters, said support oxides including Niobium Oxide, Zirconia, and Alumina.

Catalyst Sample Composition and Preparation

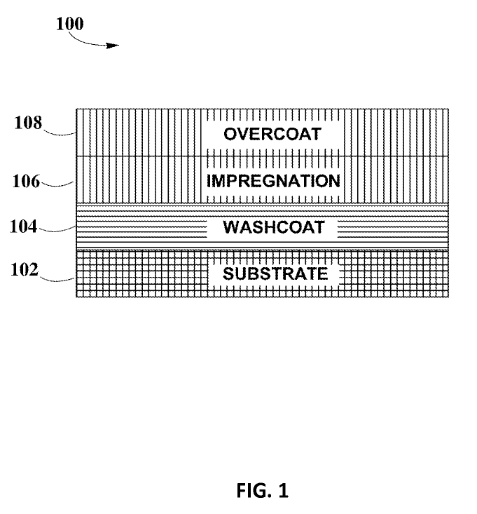

FIG. 1 is a graphical representation illustrating a catalyst structure used for Three-Way Catalyst (TWC) samples including a substrate, a washcoat layer, an impregnation layer, and an overcoat layer, according to an embodiment. In FIG. 1, TWC Structure 100 includes Substrate 102, Washcoat Layer 104, Impregnation Layer 106, and Overcoat Layer 108. In some embodiments, Washcoat Layer 104 is deposited onto Substrate 102, Impregnation Layer 106 is deposited on top of/into Washcoat Layer 104, and Overcoat Layer 108 is deposited onto Impregnation Layer 106. In other embodiments, TWC Structure 100 can include additional, fewer, or differently arranged components and layers than those illustrated in FIG. 1.

In some embodiments, Substrate 102 is implemented as a ceramic monolith substrate. In these embodiments, Substrate 102 is of a diameter, wall thickness, and cell density suitable for use in a desired application. In an example, Substrate 102 is implemented as a cordierite monolith having a diameter in the range from about 4.16 inches to about 4.66 inches. In this example, Substrate 102 is implemented as having a wall thickness in the range from about 3.5 mil to about 4.3 mil. Further to this example, Substrate 102 is implemented as having a cell density of approximately 600 cells per square inch (CPSI).

In some embodiments, Washcoat Layer 104 is implemented as a layer including one or more of an oxygen storage material, an oxide mixture, and a Platinum Group Metal (PGM)material. In these embodiments, Washcoat Layer 104 is formed by coating a substrate with a slurry at a desired coating concentration, where said slurry includes one or more of an oxygen storage material and an oxide mixture comprising one or more of Niobium Oxide, Zirconia, and Alumina. Further to these embodiments, one or more platinum group metals (e.g., Rhodium, Palladium, Platinum) are added to said oxide mixture to a desired material loading level. In other embodiments, said slurry additionally includes one or more other compatible materials, such as, for example nickel oxide. In some embodiments, the coated substrate is then calcined at a desired temperature for a specified period of time.

In an example, Washcoat Layer 104 is formed by coating Substrate 102 with a slurry having a coating concentration ranging from about 60 to about 110 grams per liter (g/L). In this example, said slurry includes an oxygen storage material (e.g., a Cerium Oxide, Zirconium Oxide, Neodymium Oxide, Yttrium Oxide, or some other fluorite phase Oxygen storage Material) in a range from about 0 percent by weight (wt %) to about 80 wt %. Further to this example, said slurry additionally includes an oxide mixture (e.g., Nb—Zr—Al) in a range from about 20 wt % to about 100 wt %. In this example, one or more PGMs are added to said oxide mixture using a suitable method (e.g., pH controlled surface adsorption) at a material loading ranging from about 7.4 grams per cubic foot (g/ft3) to about 25.7 g/ft3. Further to this example, after coating Substrate 102 with said slurry, Substrate 102 is calcined for four (4) hours at about 550° C. In this example, the oxide mixture includes niobium oxide in a range from about 1 wt % to about 25 wt %, zirconia in a range from about 1 wt % to about 60 wt %, and alumina for the remaining amount where alumina is included in an amount greater than or equal to about 30%. In another example, said slurry includes about 39 wt % oxygen storage material (OSM), 59 wt % oxide mixture (e.g., Nb—Zr—Al), and 2 wt % nickel oxide. In yet another example, said slurry includes about 40 wt % to 60% OSM and 40 wt % to 60 wt % oxide mixture (e.g., Nb—Zr—Al).

In another example, Washcoat Layer 104 is formed by coating Substrate 102 with a slurry at a coating concentration of about 180 g/I. In this example, said slurry includes an OSM and stabilized alumina. Further to this example, said slurry includes a Cerium, Zirconium, Neodymium and Yttrium Oxides OSM in a range from about 40 wt % to 60 wt % and stabilized alumina for the remaining amount. It should be understood that coating levels, ratios, PGM loadings, and the like can be modified to achieve a set of desired goals. In these examples, additional, fewer, or different components can be included to achieve said goals.

In some embodiments, Impregnation Layer 106 is implemented as a layer including one or more catalyst compositions where said layer is formed over Washcoat Layer 104. In these embodiments, said catalyst compositions include one or more PGMs and/or non-precious metals. In an example, Substrate 102 having Washcoat Layer 104 is impregnated with a water-based solution including palladium nitrate and non-precious metals, followed by calcination at about 550° C. for a specified period of time to form a mixed metal oxide. In another example, Impregnation Layer 106 includes one or more catalysts substantially free of PGMs, such as, binary Cu—Mn spinels, ternary Cu—Mn spinels, and the like.

In some embodiments, Overcoat Layer 108 is implemented as a layer that is coated on to a substrate previously coated with Washcoat Layer 104 and Impregnation Layer 106. In these embodiments, Overcoat Layer 108 is formed by coating said previously coated substrate with a slurry at a desired coating concentration where said slurry includes one or more of an oxygen storage material and an oxide mixture that includes one or more of Niobium Oxide, Zirconia Oxide, and Alumina Oxide. Further to these embodiments, one or more platinum group metals (e.g., Rhodium, Palladium, Platinum) are added to said oxide mixture (e.g., Nb—Zr—Al) at a desired material loading level. In other embodiments, said slurry additionally includes one or more other compatible materials, such as, for example nickel oxide. In these embodiments, the coated substrate is then calcined at a desired temperature for a specified period of time.

In an example, Overcoat Layer 108 is formed by coating Substrate 102, where Washcoat Layer 104 and Impregnation Layer 106 have been previously applied, with a slurry having a coating concentration ranging from about 60 to about 110 grams per liter (g/L). In this example, said slurry includes an oxygen storage material (e.g., a Cerium Oxide, Zirconium Oxide, Neodymium Oxide, Yttrium Oxide, or some other fluorite phase Oxygen storage Material) in a range from about 0 percent by weight (wt %) to about 80 wt %. Further to this example, said slurry additionally includes an oxide mixture (e.g., Nb—Zr—Al) in a range from about 20 wt % to about 100 wt %. In this example, one or more PGMs are added to said oxide mixture using a suitable method (e.g., pH controlled surface adsorption) at a material loading ranging from about 7.4 grams per cubic foot (g/ft3) to about 25.7 g/ft3. Further to this example, after coating Substrate 102 with said slurry, Substrate 102 is calcined for four (4) hours at about 550° C. In this example, the oxide mixture includes niobium oxide in a range from about 1 wt % to about 25 wt %, zirconia in a range from about 1 wt % to about 60 wt %, and alumina for the remaining amount, where alumina is included in an amount greater than or equal to about 30%. In another example, said slurry includes about 39 wt % oxygen storage material (OSM), 59 wt % oxide mixture (e.g., Nb—Zr—Al), and 2 wt % nickel oxide. In yet another example, said slurry includes about 40 wt % to 60% OSM and 40 wt % to 60 wt % oxide mixture (e.g., Nb—Zr—Al).

In other embodiments, TWC Structure 100 includes additional, fewer, or differently arranged layers than those illustrated in FIG. 1. In an example, TWC Structure 100 includes Substrate 102 and Washcoat Layer 104. In this example, Washcoat Layer 104 is implemented as a layer including an OSM and an oxide mixture at a desired ratio where Washcoat Layer 104 additionally includes one or more PGMs added to said oxide mixture at a desired material loading level. In another example, TWC Structure 100 includes Substrate 102, Washcoat Layer 104, and Overcoat Layer 108. In this example, Washcoat Layer 104 is implemented as a layer including an OSM and stabilized alumina. Further to this example, Overcoat Layer 108 is implemented as a layer including an oxide mixture where said oxide mixture includes one or more added PGMs. In yet another example, TWC Structure 100 includes Substrate 102, Washcoat Layer 104, and Overcoat Layer 108. In this example, Washcoat Layer 104 is implemented as a layer including an oxide mixture at a desired material loading level. Further to this example, Overcoat Layer 108 is implemented as a layer including an OSM and stabilized alumina.

Catalyst Testing Methodology

In some embodiments, the catalytic efficiency of TWC systems employing various catalytic materials is evaluated by performing a light-off test to determine the Temperature at which 50% Conversion (T50) of pollutants including Nitrogen Oxides (NOx), Carbon Monoxide (CO), and Hydrocarbons (HC) is achieved. In other embodiments, the catalytic efficiency of TWC systems employing various catalytic materials is further evaluated by performing a light-off test to determine the Temperature at which 90% Conversion (T90) of pollutants including NOx, CO, and HC is achieved.

In some embodiments, the T50 and T90 conversion values associated with a catalyst are evaluated by providing a core sample from the catalyst (e.g., by using a diamond core drill). In these embodiments, the core sample is then experimentally aged using heat in a controlled chemical environment. Further to these embodiments, the experimental aging simulates the aging of a catalyst associated with driving a vehicle an approximated number of miles. In an example, 1 inch diameter cores with a length of 2 inches are aged at 1000° C. in a chemical environment including 10 percent by mole (mol%) water vapor, 10 mol% carbon dioxide, varying amounts of carbon monoxide and oxygen, and nitrogen for the remaining amount. In this example, the experimental aging process simulates the thermal aging associated with driving a vehicle from about 50,000 miles to 120,000 miles. Further to this example, the experimental aging process includes simulations of both fuel cut like events (e.g., high oxygen content) and rich events (e.g., below 13 Air/Fuel (A/F) ratio units). In this example, the cores are then cooled in said chemical environment to a temperature ranging from about 200° C. to about 300° C. and are then removed from the experimental aging system.

In some embodiments, said core sample is tested on a bench flow reactor to determine TWC performance (e.g., T50, T90, etc.). In these embodiments, to perform a light-off test the core is conditioned in said bench flow reactor for at least 10 minutes at approximately 600° C. and exposed to a slightly rich gas stream (e.g., R-value of 1.05) with nearly symmetric lean and rich perturbations at a frequency of 1 Hz. In an example, a light-off test is used to determine catalytic performance. In this example, the gas stream used for the test includes 8000 ppm carbon monoxide, 2000 ppm hydrogen, 400 ppm (C3) propene, 100 ppm (C3) propane, 1000 ppm nitric oxide, 100,000 ppm water vapor, 100,000 ppm carbon dioxide, and nitrogen for the remaining amount. Further to this example, the oxygen level additionally included in the gas stream is varied, as a square wave, from 4234 ppm to 8671 ppm with a frequency of 0.5 Hz. Still further to this example, the average R-value for the gas stream is 1.05 and the square wave change in oxygen results in an air to fuel ratio span of about 0.4 A/F units. In this example, the space velocity is about 90,000 h⁻¹ at the standard conditions of 21.1° C., 1 atm with the total volume enclosed by the monolith surface used as the volume for the space velocity calculation. In another example, the gas feed employed for the test may be a standard TWC gas composition, with variable O2 concentration in order to adjust R-value from rich condition to lean condition during testing. In this example, the standard TWC gas composition includes about 8,000 ppm of CO, about 400 ppm of C₃H₆, about 100 ppm of C₃H₈, about 1,000 ppm of NOx, about 2,000 ppm of H₂, about 10% of CO₂, and about 10% of H₂O. The quantity of O₂ in the gas mix is varied to adjust the Air/Fuel (A/F) ratio within the range of R-values to test the gas stream. In yet another example, the temperature is stabilized at approximately 100° C. for about 2 minutes, and the gas temperature is increased/ramped at approximately 40° C. per minute to approximately 500° C. In this example, a gas blanket warming the core holder is increased/ramped at the substantially same set point temperature. Further to this example, the conversion of the gas pollutants is then measured and the temperature values at approximately 50% and 90% of conversion are determined.

Catalysts Tested

In some embodiments, reference samples are produced for catalytic activity comparisons and to ascertain the catalytic conversion efficiency of the materials disclosed herein. In these embodiments, a first reference sample (REF #1) and second reference sample (REF #2) are produced using conventional materials and synthesis methods. In some examples, a 0.455 L cordierite substrate having a 4.16 inch diameter, 600 CPSI cell density, and 4.3 mil wall thickness is coated with a slurry at a coating concentration of 94 g/L for REF #1 and 95 g/L for REF #2. In these examples, said slurry employed for REF #1 and REF #2 includes about 40 wt % of a proprietary Cerium, Zirconium, Neodymium, Yttrium Oxides that are fluorite phase (CZNY) OSMs. Further to this example, about 60 wt % stabilized alumina is employed for REF #1 and about 60% wt % stabilized zirconia is employed for REF #2. In other examples, rhodium is added to the oxides in the slurry via pH controlled surface adsorption at a loading of 9.4 g/ft3 for REF #1 and 9.5 g/ft3 for REF #2. In these examples, the samples are calcined to achieve coating adhesion of the ceramic layer onto the surface of the cordierite substrate.

In another example, a third reference sample (REF #3) is produced using conventional materials and synthesis methods. In this example, a 1.00 L cordierate substrate having a 4.66 inch diameter, 600 CPSI cell density, and 3.5 mil wall thickness is coated with a first slurry at a coating concentration of about 180 g/L. Further to this example, said first slurry includes about 40%wt CZNY OSM and about 60% wt % stabilized alumina. REF #3 is then calcined to achieve coating adhesion of the ceramic layer onto the surface of the cordierite substrate thereby forming a washcoat layer. In this example, REF #3 is then impregnated using a solution of Palladium and non-precious metals where the palladium concentration is about 160.7 g/ft3. Further to this example, REF #3 is then calcined to form a mixed oxide. In this example, REF #3 is coated with a second slurry at a coating concentration of 60 g/L where said second slurry includes about 40 wt % CZNY OSM and about 60% wt % stabilized zirconia. Further to this example, rhodium is added to the oxides in said second slurry via pH controlled surface adsorption methodology at a loading concentration of approximately 9.0 g/ft3. In this example, REF #3 is then calcined to achieve coating adhesion of the ceramic layer onto the surface of the washcoated and impregnated substrate thereby forming an overcoat layer. T50 and T90 values of NOx, CO, and HC associated with REF #1, REF #2, and REF #3 catalysts are detailed in Table 1 immediately below.

TABLE 1
T50 and T90 values (NOx, CO, and HC) for
REF#1, REF#2, and REF#3 catalysts.

| | |
|---|---|
| T50 (° C.) | T90 (° C.) |

| | NOx | CO | HC | NOx | CO | HC |
|---|---|---|---|---|---|---|
| REF#1 | 275.8 | 272.0 | 304.7 | 335.6 | 297.3 | 367.7 |
| REF#2 | 273.8 | 266.9 | 297.2 | 316.8 | 291.2 | 374.9 |
| REF#3 | 237.6 | 241.4 | 254.2 | 268.8 | 256.3 | 277.9 |

In some embodiments, a set of samples including the disclosed oxide mixtures (Nb—Zr—Al) are produced for catalytic activity comparisons and to ascertain the effect of differing amounts of niobium oxide (Nb₂O₅) within said oxide mixtures on catalytic activity. In these embodiments, a first catalyst (Type A), a second catalyst (Type B), a third catalyst (Type C), a fourth catalyst (Type D), and a fifth catalyst (Type E) are produced using methods substantially similar to those described in FIG. 1. Further to these embodiments, a 0.455 L cordierite substrate having a 4.16 inch diameter, 600 CPSI cell density, and 4.3 mil wall thickness is coated with a slurry at a coating concentration of 96 g/L for Type A, 94 g/L for Type B, 92 g/L for Type C, 93 g/L for Type D, and 95 g/L for Type E. In these embodiments, said slurry includes 40 wt % CZNY OSM and 60 wt % oxide mixture. Further to these embodiments, said oxide mixture includes Nb₂O₅ at 1 wt % for catalyst Type A, 2 wt % for catalyst Type B, 5 wt % for catalyst Type C, 10 wt % for catalyst Type D, and 15 wt % for catalyst Type E. Still further to these embodiments, said oxide mixture includes 20 wt % zirconia, and alumina for the remaining amount. In these embodiments, rhodium is added to the oxides in said slurry using pH controlled surface adsorption at a loading of 9.6 g/ft3 for catalyst Type A, 9.4 g/ft3 for catalyst Type B, 9.2 g/ft3 for catalyst Type C, 9.3 g/ft3 for catalyst Type D, and 9.5 g/ft3 for catalyst Type E. Further to these embodiments, the samples are then calcined to achieve coating adhesion of the ceramic layer onto the surface of the cordierite substrate, thereby forming a washcoat layer.

TABLE 2
Nb₂O₅ loading, T50 and T90 values (NOx, CO,
and HC) for catalysts Type A, B, C, D, and E.

| | T50 (° C.) | | | T90 (° C.) | | | Nb₂O₅ |
|---|---|---|---|---|---|---|---|
| | NOx | CO | HC | NOx | CO | HC | (wt %) |
| A | 263.8 | 254.8 | 285.0 | 311.5 | 271.6 | 345.9 | 1% |
| B | 262.9 | 253.3 | 280.0 | 303.0 | 267.9 | 337.4 | 2% |
| C | 263.6 | 253.2 | 279.2 | 298.3 | 267.9 | 328.7 | 5% |
| D | 261.9 | 252.1 | 277.5 | 298.9 | 267.7 | 327.1 | 10% |
| E | 260.0 | 252.7 | 272.8 | 292.7 | 264.1 | 323.0 | 15% |

In some embodiments, another set of catalysts including the disclosed oxide mixtures (Nb—Zr—Al) are produced for catalytic activity comparisons and to ascertain the effect of differing amounts of zirconia within said oxide mixtures on catalytic activity. In these embodiments, a first catalyst (Type F), a second catalyst (Type G), a third catalyst (Type H), a fourth catalyst (Type I), a fifth catalyst (Type J), and a sixth catalyst (Type K) are produced using methods substantially similar to those described in FIG. 1. Further to these embodiments, a 0.599 L cordierite substrate having a 4.66 inch diameter, 600 CPSI cell density, and 3.5 mils wall thickness is coated with a slurry at a coating concentration of 91 g/L for catalyst Type F. In these embodiments, a 0.455 L cordierite substrate having a 4.16″ diameter, 600 CPSI cell density, and 4.3 mils wall thickness is coated with said slurry at a coating level of 90 g/L for catalysts Type G and H, and 88 g/L for catalysts Type I, J, and K. Further to these embodiments, said slurry includes 40 wt % CZNY OSM and 60 wt % oxide mixture. Yet further to these embodiments, said oxide mixture includes zirconia at 10 wt % for catalyst Type F, 20 wt % for catalyst Type G, 30 wt % for catalyst Type H, 40 wt % for catalyst Type I, 50 wt % for catalyst Type J, and 60 wt % for catalyst Type K. In these embodiments, said oxide mixtures include 10 wt % Nb₂O₅ and alumina for the remaining amount. Further to these embodiments, rhodium is added to the oxides in said slurry using pH controlled surface adsorption at a loading of 9.1 g/ft3 for Type F, 9.0 g/ft3 for catalysts Type G and H, and 8.8 g/ft3 for catalysts Type I, J, and K. In these embodiments, the catalyst are then calcined to achieve coating adhesion of the ceramic layer onto the surface of the cordierite substrate, thereby forming a washcoat layer.

TABLE 3
ZrO₂ loading, T50 and T90 values (NOx, CO, and
HC) for catalysts Type F, G, H, I, and J.

| | T50 (° C.) | | | T90 (° C.) | | | ZrO₂ |
|---|---|---|---|---|---|---|---|
| | NOx | CO | HC | NOx | CO | HC | (wt %) |
| F | 264.5 | 256.6 | 281.4 | 301.6 | 271.9 | 332.2 | 10% |
| G | 263.1 | 254.4 | 276.6 | 304.4 | 267.8 | 331.6 | 20% |
| H | 266.5 | 258.7 | 282.4 | 315.0 | 271.6 | 339.5 | 30% |
| I | 272.8 | 265.1 | 285.5 | 321.1 | 277.7 | 347.6 | 40% |
| J | 272.0 | 267.9 | 293.3 | 335.7 | 331.4 | 362.9 | 50% |
| K | 277.9 | 274.6 | 302.5 | 347.7 | 346.3 | 376.2 | 60% |

In some embodiments, yet another set of catalysts including the disclosed oxide mixtures (Nb—Zr—Al) are produced for catalytic activity comparisons and to ascertain the effect of differing OSM/Oxide Mixture ratios on catalytic activity. In these embodiments, a first catalyst (Type L), a second catalyst (Type M), a third catalyst (Type N), and a fourth catalyst (Type O) are produced using methods substantially similar to those described in FIG. 1. Further to these embodiments, a 0.455 L cordierite substrate having a 4.16″ diameter, 600 CPSI cell density, and 4.3 mil wall thickness is coated with said slurry at a coating concentration of 90 g/L for catalysts Type L, M, N, and O. In these embodiments, said slurry includes 80 wt % CZNY OSM for catalyst Type L, 60 wt % CZNY OSM for catalyst Type M, 40 wt % CZNY OSM for catalyst Type N, and 20 wt % CZNY OSM for catalyst Type O. Further to these embodiments, said slurry includes 20 wt % oxide mixture for catalyst Type L, 40 wt % oxide mixture for catalyst Type M, 60 wt % oxide mixture for catalyst Type N, and 80 wt % oxide mixture for catalyst Type O. In these embodiments, said oxide mixtures include 10 wt % Nb₂O₅, 20 wt % zirconia, and alumina for the remaining amount. Further to these embodiments, rhodium is added to the oxides in said slurry using pH controlled surface adsorption at a loading of 9.1 g/ft3 for catalyst Type L, and 9.2 g/ft3 for catalysts Type M, N, and O. In these embodiments, the samples are then calcined to achieve coating adhesion of the ceramic layer onto the surface of the cordierite substrate, thereby forming a washcoat layer.

TABLE 4
OSM loading, T50 and T90 values (NOx, CO,
and HC) for catalyst Type L, M, N, and O.

| | T50 (° C.) | | | T90 (° C.) | | | OSM |
|---|---|---|---|---|---|---|---|
| | NOx | CO | HC | NOx | CO | HC | (wt %) |
| L | 297.2 | 303.0 | 332.8 | 363.1 | 385.4 | 408.5 | 80% |
| M | 287.0 | 286.5 | 318.0 | 353.0 | 361.2 | 387.9 | 60% |
| N | 262.0 | 253.5 | 278.5 | 304.4 | 265.1 | 331.0 | 40% |
| O | 258.2 | 249.4 | 274.0 | 327.5 | 260.4 | 358.4 | 20% |

In some embodiments, another set of catalysts including the disclosed oxide mixtures (Nb—Zr—Al) are produced for catalytic activity comparisons and to ascertain the effect of PGM loading on catalytic activity. In these embodiments, a first catalyst (Type P), a second catalyst (Type Q), a third catalyst (Type R), and a fourth catalyst (Type S) are produced using methods substantially similar to those described in FIG. 1. Further to these embodiments, a 0.599 L cordierite substrate having a 4.66″ diameter, 600 CPSI cell density, and 3.5 mils wall thickness is coated with said slurry at a coating concentration of 101 g/L for catalyst Type P, 103 g/L for catalysts Type Q and S, and 99 g/L for catalyst Type R. In these embodiments, said slurry includes 40 wt % CZNY OSM and 60 wt % oxide mixture, said oxide mixture having 10 wt % Nb2O5, 20 wt % Zirconia, and alumina for the remaining amount. Further to these embodiments, Rhodium and/or Platinum are added to the oxides in said slurry using pH controlled surface adsorption. Yet further to these embodiments, Rhodium is attached to the oxides in said slurry at a loading of 15.1 g/ft3 for catalyst Type P, 25.7 g/ft3 for catalyst Type Q, 7.4 g/ft3 for catalyst Type R, and 12.7 g/ft3 for catalyst Type S. In these embodiments, Platinum is added to the oxides in said slurry at 7.4 g/ft3 for catalyst Type R and 12.7 g/ft3 for catalyst Type S. Further to these embodiments, the catalysts are then calcined to achieve coating adhesion of the ceramic layer onto the surface of the cordierite substrate.

TABLE 5
PGM loading, T50 and T90 values (NOx, CO,
and HC) for catalysts Type P, Q, R, and S.

| | T50 (° C.) | | | T90 (° C.) | | | PGM Load (g/ft³) | |
|---|---|---|---|---|---|---|---|---|
| | NOx | CO | HC | NOx | CO | HC | Pt | Rh |
| P | 252.4 | 241.9 | 260.9 | 280.1 | 255.0 | 307.5 | 0.0 | 15.1 |
| Q | 242.7 | 236.0 | 252.0 | 261.3 | 247.7 | 291.2 | 0.0 | 25.7 |
| R | 271.1 | 264.4 | 287.9 | 301.1 | 279.6 | 334.7 | 7.4 | 7.4 |
| S | 259.7 | 253.6 | 274.8 | 285.8 | 268.0 | 317.5 | 12.7 | 12.7 |

In some embodiments, another catalyst (Type T) including the disclosed oxide mixture (Nb—Zr—Al) is produced for catalytic activity comparisons and to ascertain the performance of said oxide mixture in overcoats. In these embodiments, catalyst Type T is produced using methods substantially similar to those described in FIG. 1. Further to these embodiments, a 1.00 L cordierite substrate with a 4.66″ diameter, 600 CPSI cell density, 3.5 mils wall thickness is coated with a first slurry at a coating concentration of 180 g/L, said first slurry including 40 wt % CZNY OSM and 60 wt % stabilized alumina. Catalyst Type T is then calcined to achieve coating adhesion onto the substrate, thereby forming a washcoat layer. Yet further to these embodiments, an impregnation layer is applied onto the washcoat layer using a Palladium Nitrate and non-precious metal water-based solution and having a palladium loading concentration of 160.7 g/ft3. In these embodiments, catalyst Type T is then calcined to form a mixed oxide. Further to these embodiments, catalyst Type T is then coated with a second slurry that includes 40 wt % CZNY OSM and 60 wt % oxide mixture. In these embodiments, said oxide mixture includes 10 wt % Nb₂O₅, 20 wt % zirconia, and alumina for the remaining amount. In these embodiments, rhodium is added to the oxides in said second slurry using pH Controlled Surface Adsorption at a loading of 9 g/ft3. Further to these embodiments, catalyst Type T is then calcined to achieve coating adhesion of catalyst Type T onto the impregnation and washcoat layers, thereby forming an overcoat layer.

TABLE 6
Nb₂O₅ loading, T50 and T90 values (NOx,
CO, and HC) for catalyst Type T.

| | T50 (° C.) | | | T90 (° C.) | | | Nb₂O₅ |
|---|---|---|---|---|---|---|---|
| | NOx | CO | HC | NOx | CO | HC | (wt %) |
| T | 228.5 | 232.7 | 242.7 | 254.3 | 244.0 | 269.1 | 10% |

In some embodiments, another set of catalysts including the disclosed oxide mixtures (Nb—Zr—Al) are produced for catalytic activity comparisons and to ascertain the compatibility of oxide mixtures disclosed herein with nickel oxide. In these embodiments, a first catalyst (Type U) and a second catalyst (Type V) are produced using methods substantially similar to those described in FIG. 1. Further to these embodiments, a 0.599 L cordierite substrate having a 4.66 inch diameter, 600 CPSI cell density, and 3.5 mils wall thickness is coated with a slurry at a coating level of 96 g/L for catalysts Type U and V. Yet further to these embodiments, said oxide slurry includes 40 wt % CZNY OSM and 60 wt % oxide mixture for catalyst Type U, and 39 wt % CZNY OSM, 59 wt % oxide mixture, and 2% nickel oxide for catalyst Type V. In these embodiments, said oxide mixture includes 10 wt % Nb₂O₅, 20 wt % zirconia, and alumina for the remaining amount. Further to these embodiments, rhodium is added to the oxides in said slurry using pH Controlled Surface Adsorption at a loading of 9.6 g/ft3 for catalyst Type U and 9.5 g/ft³ for catalyst Type V. Yet further to these embodiments, catalysts Type U and V catalysts are then calcined to achieve coating adhesion of the ceramic layer onto the substrate, thereby forming a washcoat layer.

TABLE 7
NiO loading, T50 and T90 values (NOx,
CO, and HC) for catalysts Type U and V.

| | T50 (° C.) | | | T90 (° C.) | | | NiO |
|---|---|---|---|---|---|---|---|
| | NOx | CO | HC | NOx | CO | HC | (wt %) |
| U | 259.9 | 250.7 | 274.0 | 294.2 | 266.7 | 323.6 | 0% |
| V | 260.9 | 248.4 | 272.9 | 294.0 | 262.8 | 322.5 | 2% |

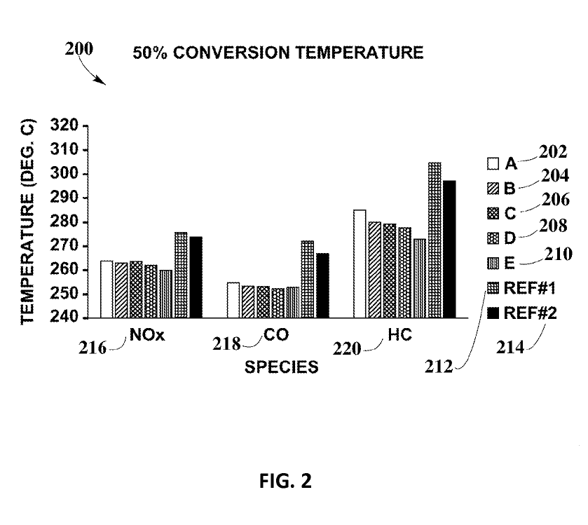

FIG. 2 is a graphical representation illustrating a comparison of T50 values of NOx, CO, and HC for REF #1, REF #2, (see Table 1) and catalysts Type A, B, C, D, and E (see Table 2), according to an embodiment. In FIG. 2, T50 Chart 200 illustrates the 50% conversion temperature value for NOx 216, CO 218, and HC 220 associated with catalyst Type A 202, Type B 204, Type C 206, Type D 208, Type E 210, REF #1 212, and REF #2 214.

In some embodiments, a decreasing trend in 50% conversion temperature values is observed as the amount of Nb₂O₅ within the oxide mixture increases from 1 wt % in catalyst Type A 202 to 15 wt % in catalyst Type E 210. In these embodiments, it is observed that catalysts Type A 202, Type B 204, Type C 206, Type D 208, and Type E 210 compare favorably to REF #1 212 and REF #2 214, thereby indicating an improvement associated with the inclusion of Nb₂O₅ within the oxide mixture.

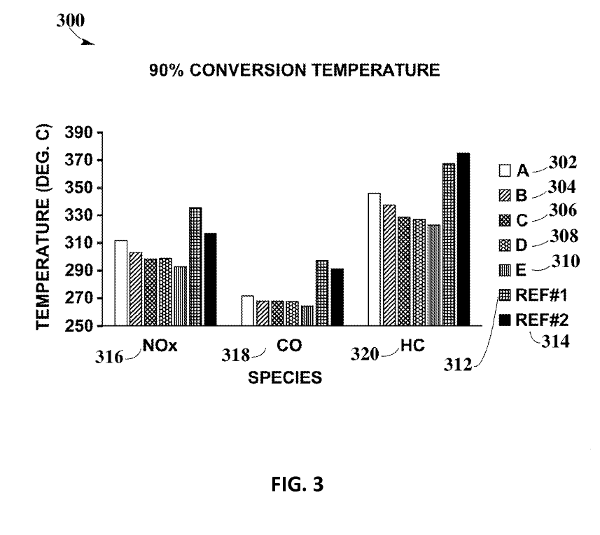

FIG. 3 is a graphical representation illustrating a comparison of T90 values of NOx, CO, and HC for REF #1, REF #2 (see Table 1), and catalysts Type A, B, C, D, and E (see Table 2), according to an embodiment. In FIG. 3, T90 Chart 300 illustrates the 90% conversion temperature value for NOx 316, CO 318, and HC 320 associated with catalysts Type A 302, Type B 304, Type C 306, Type D 308, Type E 310, REF #1 312, and REF #2 314.

In some embodiments, a decreasing trend in 90% conversion temperature values is observed as the amount of Nb₂O₅ within the oxide mixture increases from 1 wt % in catalyst Type A 302 to 15 wt % in catalyst Type E 310. In these embodiments, it is observed that catalysts Type A 302, Type B 304, Type C 306, Type D 308, and Type E 310, compare favorably to REF #1 312 and REF #2 314, thereby indicating an improvement associated with the inclusion of Nb₂O₅ within the oxide mixture.

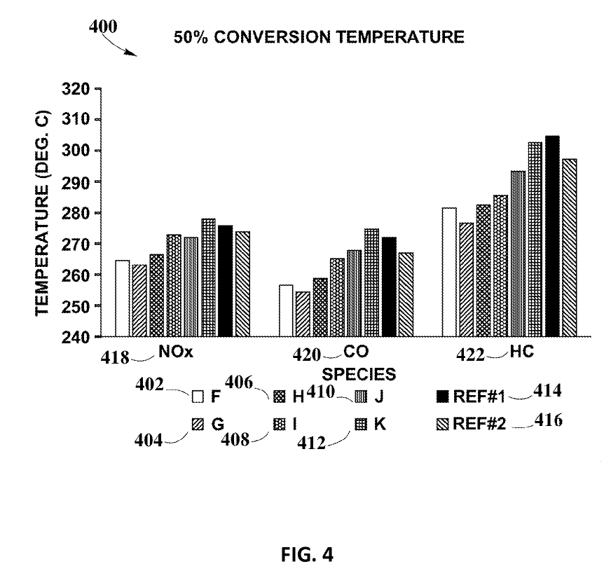

FIG. 4 is a graphical representation illustrating a comparison of T50 values of NOx, CO, and HC for REF #1, REF #2 (see Table 1), and catalysts Type F, G, H, I, J, and K (see Table 3), according to an embodiment. In FIG. 4, T50 Chart 400 illustrates the 90% conversion temperature value for NOx 418, CO 420, and HC 422 associated with catalysts Type F 402, Type G 404, Type H 406, Type I 408, Type J 410, Type K 412, REF #1 414, and REF #2 416.

In some embodiments, a non-linear trend in 50% conversion temperature values is observed as the amount of Zirconia within the oxide mixture increases from 10 wt % in catalyst Type F 402 to 60 wt % in catalyst Type K 412. In these embodiments, it is observed that catalysts Type F 402, Type G 404, and Type H 406 compare favorably to REF #1 414 and REF #2 416, thereby indicating an improvement associated with the inclusion of Zirconia within the oxide mixture up to a threshold amount (e.g., catalyst Type H 406).

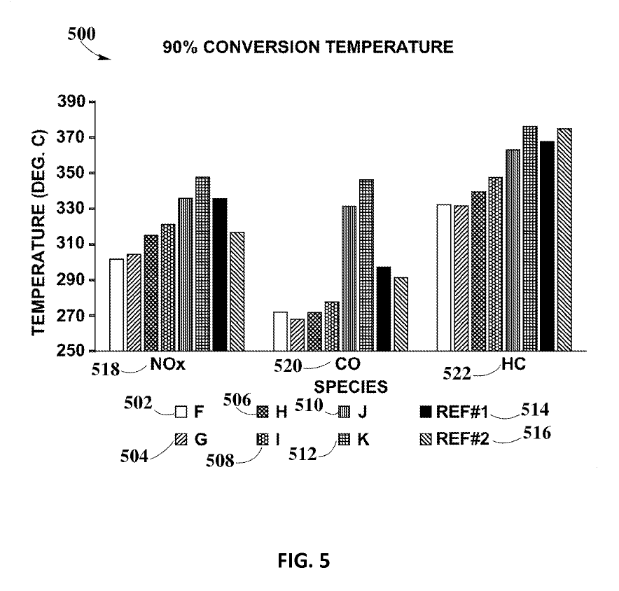

FIG. 5 is a graphical representation illustrating a comparison of T90 values of NOx, CO, and HC for REF #1, REF #2 (see Table 1), and catalysts Type F, G, H, I, J, and K (see Table 3), according to an embodiment. In FIG. 5, T90 Chart 500 illustrates the 90% conversion temperature value for NOx 518, CO 520, and HC 522 associated with catalysts Type F 502, Type G 504, Type H 506, Type I 508, Type J 510, Type K 512, REF #1 514, and REF #2 516.

In some embodiments, an increasing trend in 90% conversion temperature value is observed as the amount of Zirconia within the oxide mixture increases from 10 wt % in catalyst Type F 502 to 60 wt % in catalyst Type K 512. In these embodiments, it is observed that catalyst Type F 502 and catalyst Type G 504 compare favorably to REF #1 514, and REF #2 516 when analyzing NOx 518, thereby indicating an improvement associated with the inclusion of Zirconia within the oxide mixture up to a threshold amount (e.g., catalyst Type G 504). Further to these embodiments, it is observed that catalysts Type F 502, Type G 504, Type H 506, and Type I 508 compare favorably to REF #1 514, and REF #2 516 when analyzing CO 520 and HC 522, thereby indicating an improvement associated with the inclusion of Zirconia within the oxide mixture up to a threshold amount.

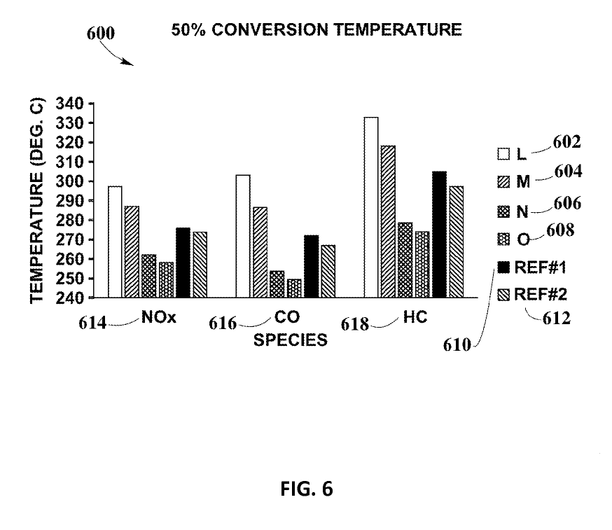

FIG. 6 is a graphical representation illustrating a comparison of T50 values of NOx, CO, and HC for REF #1, REF #2 (see Table 1), and catalysts Type L, M, N, and O (see Table 4), according to an embodiment. In FIG. 6, T50 Chart 600 illustrates the 50% conversion temperature value for NOx 614, CO 616, and HC 618 associated with catalyst Type L 602, Type M 604, Type N 606, and Type O 608, REF #1 610 and REF #2 612.

In some embodiments, a decreasing trend in 50% conversion temperature value is observed as the amount of OSM within the applied washcoat decreases from 80 wt % in catalyst Type L 602 to 20 wt % in catalyst Type O 608. In these embodiments, it is observed that catalyst Type N 606 and catalyst Type O 608 compare favorably to REF #1 610, and REF #2 612, thereby indicating an improvement associated with the inclusion of OSM within washcoat below a threshold (e.g., catalyst Type O 608).

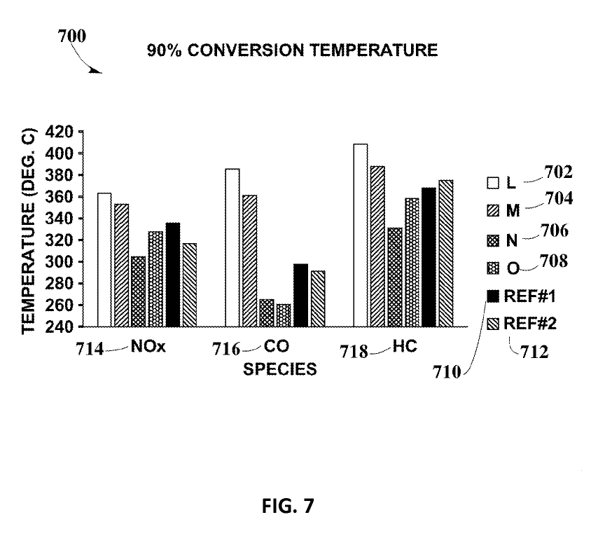

FIG. 7 is a graphical representation illustrating a comparison of T90 values of NOx, CO, and HC for REF #1, REF #2 (see Table 1), and catalysts Type L, M, N, and O (see Table 4), according to an embodiment. In FIG. 7, T90 Chart 700 illustrates the 90% conversion temperature value for NOx 714, CO 716, and HC 718 associated with catalysts Type L 702, Type M 704, Type N 706, and Type O 708, REF #1 710 and REF #2 712.

In some embodiments, a non-linear trend in 90% conversion temperature values is observed as the amount of OSM within the applied washcoat decreases from 80 wt % in catalyst Type L 702 to 20 wt % in catalyst Type O 708. In these embodiments, it is observed that catalyst Type N 706 and catalyst Type O 708 compare favorably to REF #1 710, and REF #2 712, thereby indicating an improvement associated with the inclusion of OSM within washcoat below a threshold, where catalyst Type N 706 performs favorably when compared to catalyst Type O 708.

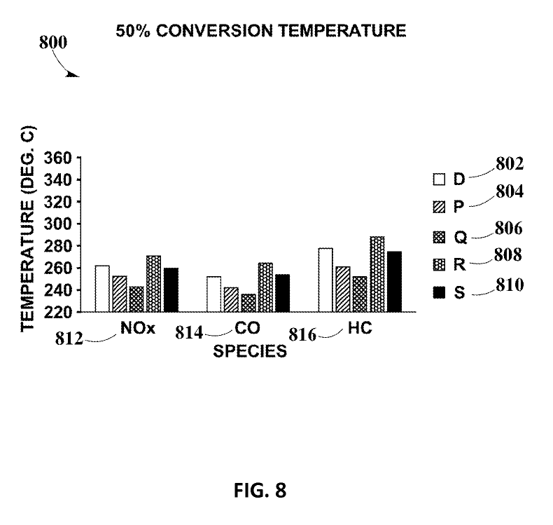

FIG. 8 is a graphical representation illustrating a comparison of T50 values of NOx, CO, and HC for catalysts Type D (see Table 2), P, Q, R, and S (see Table 5), according to an embodiment. In FIG. 8, T50 Chart 800 illustrates the 50% conversion temperature value for NOx 812, CO 814, and HC 816 associated with catalysts Type D 802, Type P 804, Type Q 806, Type R 808, and Type S 810.

In some embodiments, a decreasing trend in 50% conversion temperature values is observed as the Rh increases from 9.3 g/ft3 in catalyst Type D 802 to 25.7 wt % in catalyst Type Q 806. In these embodiments, it is observed that catalyst samples including only rhodium as the PGM added to the oxide mixture (e.g., catalysts Type D 802, Type P 804, and Type Q 806) compare favorably at similar total PGM loadings to samples including Platinum and Rhodium added to the oxide mixture (e.g., catalysts Type R 808 and Type S 810).

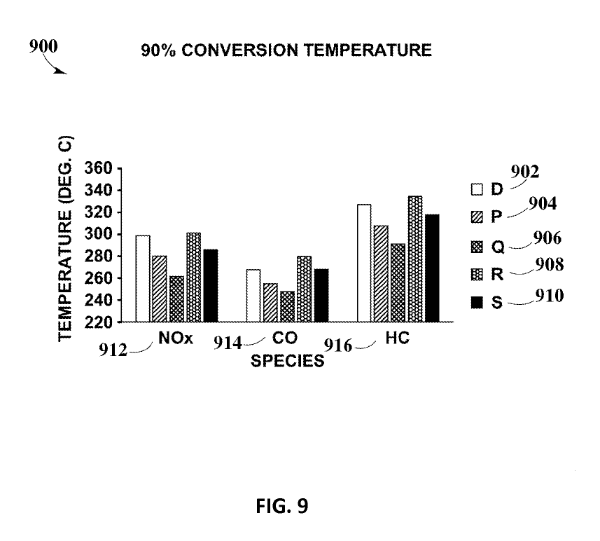

FIG. 9 is a graphical representation illustrating a comparison of T90 values of NOx, CO, and HC for catalysts Type D (see Table 2), P, Q, R, and S (see Table 5), according to an embodiment. In FIG. 9, T90 Chart 900 illustrates the 90% conversion temperature values for NOx 912, CO 914, and HC 916 associated with catalysts Type D 902, Type P 904, Type Q 906, Type R 908, and Type S 910.

In some embodiments, a decreasing trend in 90% conversion temperature values is observed as the Rh increases from 9.3 g/ft3 in catalyst Type D 902 to 25.7 wt % in catalyst Type Q 906. In these embodiments, it is observed that catalyst samples including only rhodium as the PGM added to the oxide mixture (e.g., catalysts Type D 902, Type P 904, and Type Q 906) compare favorably at similar total PGM loadings to samples including Platinum and Rhodium added to the oxide mixture (e.g., catalysts Type R 908 and Type S 910).

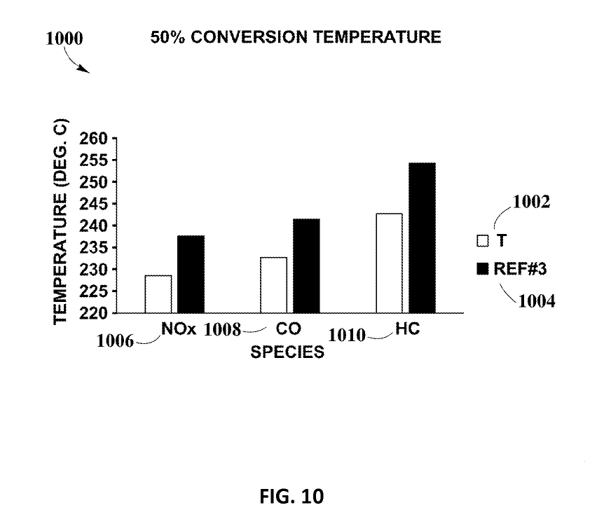

FIG. 10 is a graphical representation illustrating a comparison of T50 values of NOx, CO, and HC for catalyst Type T (see Table 6) and REF #3 (see Table 1), according to an embodiment. In FIG. 10, T50 Chart 1000 illustrates the 50% conversion temperature values for NOx 1006, CO 1008, and HC 1010 associated with catalysts Type T 1002 and REF #3 1004. In some embodiments, a decrease in 50% conversion temperature values is observed with the use of an oxide mixture within the overcoat, as catalyst Type T 1002 includes said oxide mixture within the overcoat, whereas REF #3 1004 includes stabilized alumina in the overcoat.

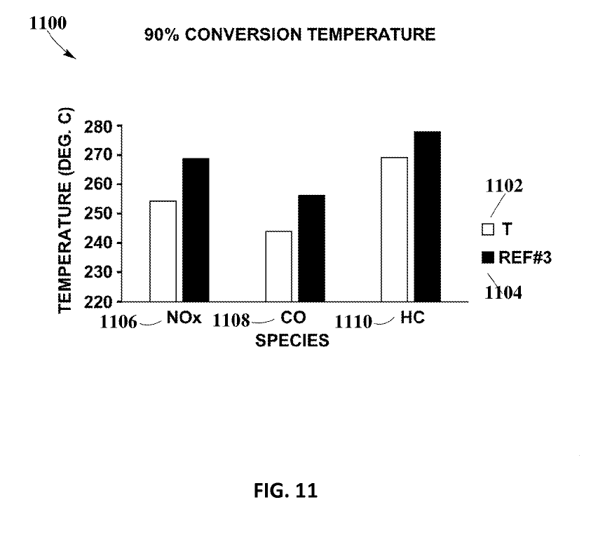

FIG. 11 is a graphical representation illustrating a comparison of T90 values of NOx, CO, and HC for catalyst Type T (see Table 6) and REF #3 (see Table 1), according to an embodiment. In FIG. 11, T90 Chart 1100 illustrates the 90% conversion temperature values for NOx 1106, CO 1108, and HC 1110 associated with catalysts Type T 1102 and REF #3 1104. In some embodiments, a decrease in 90% conversion temperature values is observed with the use of an oxide mixture within the overcoat, as catalyst Type T 1102 includes said oxide mixture within the overcoat, whereas REF #3 1004 includes stabilized alumina within the overcoat.

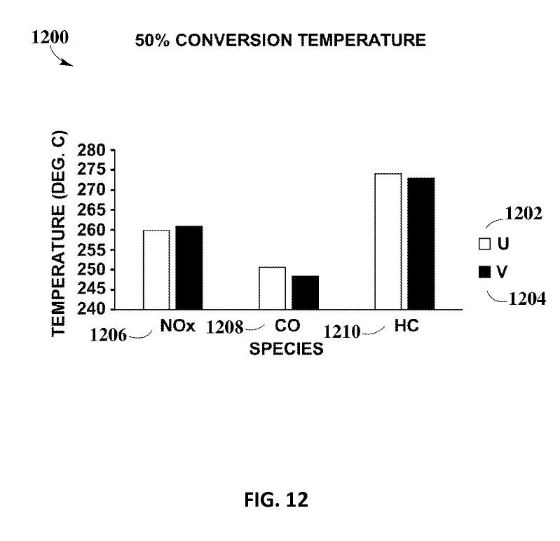

FIG. 12 is a graphical representation illustrating a comparison of T50 values of NOx, CO, and HC for catalysts Type U and Type V (see Table 7), according to an embodiment. In FIG. 12, T50 Chart 1200 illustrates the 50% conversion temperature values for NOx 1206, CO 1208, and HC 1210 associated with catalysts Type U 1202 and Type V 1204. In some embodiments, a substantially similar catalytic behavior in 50% conversion temperature values is observed for catalyst Type U 1202 and Type V 1204, thereby indicating that oxide mixtures disclosed herein are compatible with the use of NiO.

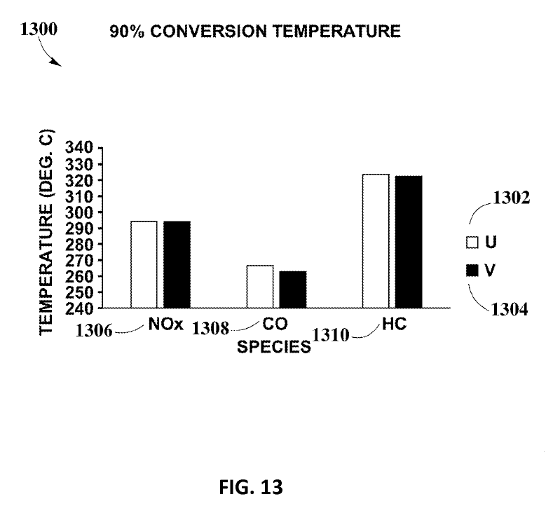

FIG. 13 is a graphical representation illustrating a comparison of T90 values of NOx, CO, and HC for catalysts Type U and Type V (see Table 7), according to an embodiment. In FIG. 13, T90 Chart 1300 illustrates the 90% conversion temperature values for NOx 1306, CO 1308, and HC 1310 associated with catalysts Type U 1302 and Type V 1304. In some embodiments, a substantially similar catalytic behavior in 90% conversion temperature values is observed for catalyst Type U 1302 and catalyst Type V 1304, thereby indicating that oxide mixtures disclosed herein are compatible with the use of NiO.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A catalyst system, comprising:
a substrate;
a washcoat deposited on the substrate; and
an overcoat;
wherein at least one of the group consisting of the washcoat and the overcoat comprises about 20 (w/w) to about 80 (w/w) of an oxide mixture and 0 (w/w) to about 80 wt % of an oxygen storage material; and
wherein the oxide mixture comprises about 1 (w/w) to about 25 (w/w) niobium oxide, about 1 (w/w) to about 60 (w/w) zirconia, and about 30 (w/w) to about 98 (w/w) alumina.

2. The catalyst system of claim 1, wherein the oxide mixture further comprises about 0 (w/w) to about 2 (w/w) NiO.

3. The catalyst system of claim 1, wherein the oxide mixture consists of niobium oxide, zirconia, and alumina.

4. The catalyst system of claim 1, wherein the oxide mixture consists of niobium oxide, zirconia, NiO, and alumina.

5. The catalyst system of claim 1, wherein the oxide mixture comprises about 1 (w/w) to about 50 (w/w) zirconia.

6. The catalyst system of claim 1, wherein the at least one of the group consisting of the washcoat and the overcoat comprises about 60 wt % to about 80 wt % of an oxide mixture and 0 (w/w) to about 40 (w/w) of an oxygen storage material.

7. The catalyst system of claim 1, wherein the at least one of the group consisting of the washcoat and the overcoat is loaded with about 7.4 g/ft³ to about 25.7 g/ft³ rhodium and 0 g/ft³ to about 12.7 g/ft³ platinum.

8. The catalyst system of claim 7, wherein the at least one of the group consisting of the washcoat and the overcoat is loaded with about 12.7 g/ft³ to about 25.7 g/ft³ rhodium.

9. The catalyst system of claim 1, wherein the washcoat comprises an OSM and alumina, wherein the catalyst system further comprises at least one impregnation layer, wherein the at least one impregnation layer includes palladium.

10. The catalyst system of claim 9, wherein the overcoat comprises about 40 (w/w) OSM and about 60 (w/w) of the oxide mixture.

11. The catalyst system of claim 10, wherein the oxide mixture comprises about 10 (w/w) niobium, oxide, about 20 wt % zirconia, and about 70 (w/w) alumina.

12. The catalyst system of claim 10, wherein the oxide mixture consists of about 10 (w/w) niobium, oxide, about 20 (w/w) zirconia, and about 70 (w/w) alumina.

13. The catalyst system of claim 10, wherein the oxide mixture comprises about 0 (w/w) to about 2 (w/w) NiO.

14. The catalyst system of claim 10, wherein the oxide mixture comprises about 10 (w/w) niobium, oxide, about 20 (w/w) zirconia, about 0 (w/w) to about 2 (w/w) NiO, and about 68 (w/w) to about 70 (w/w) alumina.

15. The catalyst system of claim 14, wherein the oxide mixture consists of about 10 (w/w) niobium, oxide, about 20 (w/w) zirconia, about 0 (w/w) to about 2 (w/w) NiO, and about 68 (w/w) to about 70 (w/w) alumina.

16. The catalyst system of claim 9, wherein the oxide mixture comprises about 10 (w/w) niobium, oxide, about 20 (w/w) zirconia, and about 68 (w/w) to about 70 (w/w) alumina.

17. The catalyst system of claim 9, wherein the oxide mixture comprises about 10 (w/w) niobium, oxide, about 20 (w/w) zirconia, about 0 (w/w) to about 2 (w/w) NiO, and about 68 (w/w) to about 70 (w/w) alumina.

18. The catalyst system of claim 1, wherein the at least one of the group consisting of the washcoat and the overcoat is loaded with about 25.7 g/ft³ rhodium.

19. The catalyst system of claim 1, wherein the at least one of the group consisting of the washcoat and the overcoat is the washcoat.

20. The catalyst system of claim 1, wherein the at least one of the group consisting of the washcoat and the overcoat is the overcoat.
